(19) United States
(12) Patent Application Publication
(10) Pub. No.: US 2022/0405437 A1
(43) Pub. Date: Dec. 22, 2022

(54) Method for Modeling a Network Topology of a Low-Voltage Network

(71) Applicant: Siemens Aktiengesellschaft, Munchen (DE)

(72) Inventors: Alfred EINFALT, Wien (AT); Juliana KAINZ, Wien (AT); Marta SABOU, Wien (AT); Andreas SCHILDORFER, Tulln an der Donau (AT); Florian KINTZLER, Wien (AT)

(21) Appl. No.: 17/840,709

(22) Filed: Jun. 15, 2022

(30) Foreign Application Priority Data
Jun. 16, 2021 (EP) 21179824

(51) Int. Cl. G06F 30/18; G06F 16/901; G06Q 50/06

(52) U.S. Cl. CPC G06F 30/18; G06F 16/9024; G06Q 50/06

(57) ABSTRACT

A method for modeling a network topology of a subarea of a low-voltage network, wherein the network topology of the subarea of the low-voltage network is dynamically changeable by switching on, over and/or off components and/or by adding or removing components, where the network topology is modeled as a graph with nodes and edges, states valid for all edges of the graph at an initialization time are determined and assigned to the edges as the respective first state instance, with each subsequent change to the network topology, the respective current states valid for the respective edge from a time of the change to the network topology are determined for the edges of the graph, and each edge of the graph is assigned the respective state determined and currently valid from the time of the respective change to the network topology as a respective further state instance together with a timestamp.

### BACKGROUND OF THE INVENTION

### 1. Field of the Invention

The present invention relates to a computer-implemented method for modeling a network topology of at least a subarea of a low-voltage network comprising components and connecting points to which the components are connected, where the network topology of at least the subarea of the low-voltage network is dynamically changed by switching on, over and/or off components, in particular lines, and/or by adding or removing components, in particular operating equipment, consumers and/or energy-generating units or energy storage units.

### 2. Description of the Related Art

Devices for lifting and stabilizing loads are used, above all, in automotive assemblies to transport vehicle parts or transport the vehicle to be assembled between the individual assembling locations in the respective stage of assembly of the vehicle. For this purpose, the frame is usually horizontally displaceable on a rail; the cross-beam via the hoist ropes articulated thereon is adjustable for height via hoists disposed on the frame.

The increasing implementation of decentralized, mostly renewable, energy generation plants (e.g., photovoltaic power stations, and/or wind turbines) has placed major challenges on the conventional operation of energy supply networks. In addition, the development of electromobility and the associated increased substitution of other forms of energy transmission by electricity are giving rise to further challenges. Furthermore, the formation of “energy communities” is seen as an essential component of the energy turnaround and will give it an additional boost by the timely implementation of corresponding EU directives (for example, the Renewable Energy Directive, the Directive on Common Rules for the Internal Market for Electricity), which are also called the “Winter Package”, in the respective national bills. So-called smart grids or intelligent power networks are often seen as a solution to problems in connection with decentralized feed-in of, such wind power and/or solar energy, where network stability is often jeopardized by decentralized feed-in, in particular into a low-voltage network.

Low-voltage networks are part of the energy supply network for the distribution of electrical energy to a large proportion of final consumers (for example, households). In the case of decentralized energy generation, electrical energy can also be fed locally into a low-voltage network from energy generators (for example, photovoltaic power stations, fuel cells, and/or small wind turbines) and/or from flexible consumers or energy storage units (for example, batteries, heat pumps, and/or charging stations for e-mobility). In addition to consumers, local energy generators and/or energy storage units, a low-voltage network also has network operating equipment, such as transformers, and/or lines, as components.

To avoid voltage losses, the spatial extent of low-voltage networks is limited to a range of a few 100 m to a few kilometers and are therefore supplied regionally from a higher-level medium-voltage network via transformer stations, also called substations, network substations or secondary substations. For this purpose, for example, a medium-voltage output of a transformer of the transformer station is linked to a feed-in unit in the medium-voltage network via a corresponding connecting point.

From a topological viewpoint, low-voltage networks are usually divided into a plurality of line strands or branches starting from the feed-in area from the higher-level medium-voltage network and a main distribution center (for example, a transformer station), which are linked to a low-voltage output of the transformer of the transformer station via a common busbar. With a busbar as a connecting point or nodal point or central distributor of electrical energy, all connected incoming and outgoing line strands of the low-voltage network usually converge and can, for example, be switched on, off, or over via switchgear or associated disconnectors and/or circuit breakers. The individual consumers or consumer groups as loads and/or possibly decentralized energy generators (for example, photovoltaic power stations, fuel cells, and/or energy storage units) are usually connected to the line strands or branches via corresponding connecting points or nodal points, such as so-called loop boxes for further branches in the network and/or so-called disconnection boxes at, for example, property boundaries, where usually at least two lines meet at the connecting points.

Operators of energy supply networks, such as low-voltage networks, usually have to fulfill a, possibly legally prescribed, supply mandate and, for example, ensure standard-compliant network operation, such as the observance of voltage limits in accordance with the EN50160 standard (for example voltage limits of +/−10% of the nominal voltage). However, additional participants will operate the systems closer to the limits, thus, for example, necessitating transition from a rather passive operational management based on planning reserves to a more active operational management based on current measured values (for example, measured values for electric current and/or voltage) from the energy supply network, in particular a low-voltage network.

Depending upon the supply area, the system limits and thus the network stability can mainly be at risk in two areas. In supply networks or low-voltage networks in rural areas, the predominant problem is voltage maintenance or the so-called U problem. In the case of supply networks or low-voltage networks in urban areas, which tend to have short line lengths due to the load density, the predominant problem is not so much voltage maintenance, but rather the utilization of the operating equipment, also called the I problem. Decentralized feed-in of energy via, for example, alternative energy generation (for example, photovoltaics, wind power, and/or energy storage units) can initially reduce high utilization of operating equipment, such as lines and transformers. In very rare cases, power limits are violated during energy recovery. Of course, in suburban regions, for example, network sections within a network region may tend to have both the rural and the urban characteristics described. In order to maintain standard-compliant network operation, such as in accordance with the EN50160 standard, even if a subscriber is a long distance from the supply connector of the low-voltage network or to prevent overloading of the operating equipment, it is, for example, possible either to expand the network or to use active network management via a corresponding system.

An active network management system of this kind, for example, specifically accesses generators, flexible consumers or even energy storage units in the network and controls them, for example, with a so-called demand-response method such that standard-compliant network operation can be maintained. Stable operation of a low-voltage network via an active network management system is based on valid measurement data (for example, voltage and/or electric current values, active power values, and/or reactive power values) from the network in question.

At present, measurement data is measured by measuring units installed in the low-voltage network, wherein measuring units installed at connecting points (for example busbars, loop boxes, etc.) and/or measuring sensors installed at the connecting point of the respective low-voltage network (for example in transformer stations or local network stations) and so-called intelligent meters or smart meters installed with final consumers are, for example, used for the measurements. For example, in this context, after installation of an intelligent meter or a measuring sensor in a low-voltage network, there is a so-called node-specific assignment or assignment to a connecting point or nodal point (for example, transformer station, busbar, and/or loop box) in the network.

In the case of smart meters, the node-specific assignment occurs, for example, by linking customer numbers, metering point numbers or serial numbers in the corresponding processing system of a metering point operator. If this operator is identical to the distribution network operator, this assignment is then, for example, available to middleware units (for example, aggregators, decentralized network regulators in transformer stations) and, for example, enables network management systems to classify and further process incoming measurement data from intelligent meters with regard to their position in the network. However, if the metering point operators and the network operators are not identical, then there is a certain hurdle, for example, with regard to making information about the positions of smart meters in the network available.

In the case of measuring units installed in the low-voltage network, which units can, for example, be attached to connecting points or nodal points, such as a transformer station, busbar, and/or loop box, but are hardly ever installed nowadays, it is, for example, possible to use corresponding data from a geographical information system for node-specific assignment to the respective connecting points. Since this data usually has to be updated manually in the corresponding systems, there may be a delay in correcting the respective currently valid network topology, for example, in the case of switchovers, etc. Systems, such as network management systems, which depend on topology information valid at the time of measurement for correct interpretation of the measurement data, may then access a network model that is no longer valid or a network topology of the low-voltage network that is out of date at the time of measurement. This can subsequently lead to an incorrect interpretation or misinterpretation of the respective measurement data. Furthermore, manual acquisition of the topology or manual updating of any existing plans is not very effective due to the high complexity of the low-voltage networks.

Particularly in order to enable loss-optimized solutions for the U problem and especially for the I problem, it is also essential to have at least approximate knowledge of the respective valid network topology of the respective low-voltage network or of the respective subarea of the low-voltage network. In order to be able to correctly interpret measurement data collected in the low-voltage network measuring units, measuring sensors and smart meters, it is therefore necessary that the network topology available for network management systems was valid and current at the time of the respective acquisition of the measurement data or for it to take account of dynamic changes to the network topology, for example, due to switching state changes (e.g., on/off) in switchgear, and the like.

### SUMMARY OF THE INVENTION

In view of the foregoing, it is therefore an object of the invention to provide a method for modeling a network topology for at least a subarea of a low-voltage network with which a respective valid network topology of at least the subarea of the low-voltage network can be determined and output in a simple manner for an arbitrarily specifiable query time.

This and other objects and advantages is achieved in accordance with the invention by a computer-implemented method in which a network topology of at least a subarea of a low-voltage network with components (for example, consumers, energy feeders, energy generators, energy storage units and operating equipment, such as transformers, and/or lines), which are connected to the low-voltage network via connecting points (for example busbars, loop boxes, disconnection boxes, etc.), is initially modeled as a graph or graph model with nodes and edges. Here, the components of the low-voltage network are represented as edges or as edges with an associated start or end node. The connecting points or nodal points, i.e., busbars, loop boxes, disconnection boxes, at which at least two or more lines meet in order to connect or link components are represented as nodes. For an initialization time, a state valid at an initialization time is determined for each edge of the graph model and then assigned to the respective edge as the first state instance or initial instance, where this first state instance is valid for the initialization time. Furthermore, upon every change to the network topology, a respective current state that is valid for the respective edge of the graph from a time of the respective change to the network topology is determined for each edge of the graph. Each edge of the graph is then assigned the respective state determined and valid from the time of the respective change to the network topology as a respective further state instance together with a timestamp. Here, the timestamp of the respective further state instance indicates the time of the change.

The main aspect of the present invention is that determining the respective states of the edges in the graph, which can be changed by topology changes, and assigning the respective currently valid states as state instances with a timestamp to the corresponding edges enables dynamic and temporal changes to the network topology to be incorporated into the model of the network topology of the low-voltage network. This is also advantageous because, due to the modeling according to the invention, the infrastructure that is basically available in the low-voltage network is still available in the model, even if certain components of the network are deactivated or switched off at a specific time. Systems, such as for network monitoring, which access the modeling of the network topology or the graph model in accordance with the invention, are thus provided in a simple manner with information about a network topology of the low-voltage network in which, for example, dynamic changes to the network topology, such as the switching on, over or off of lines, and/or circuits in switchgear, is taken into account, for example. It is also, for example, possible to derive a valid network topology of the low-voltage network or a subarea thereof that is valid at a specifiable time from this information. Thus, dynamic changes to the network topology can be tracked very easily afterward. This enables incorrect interpretations of measurement data to be very easily avoided, because the modeling of the network topology in accordance with the invention makes it easy to keep it consistent with measurement data from the network, such as recorded time series of measured values for electric current, voltage and/or power, in a simple manner.

It is advantageous if, in the event of a respective change to the network topology, an assignment of respective further state instances with an associated timestamp is reduced to those edges of the graph whose respective current state was changed by the respective change to the network topology. This means that, in the event of a topology change to the network, a new or further state instance is only assigned to those edges for which the currently valid state determined for the topology change has also changed. Thus, edges whose state remains unchanged, for example, do not receive a further state instance. In this way, the number of state instances in the graph is significantly reduced in the longer term in a simple manner.

It is also advantageous for the respective change to the network topology of at least the subarea of the low-voltage network to be combined in the graph or in the graph model to form an event or to be represented as an event. In this context, an event ideally combines the entirety of all state changes to edges at the time of the respective change to the network topology. In this context, the event comprises the entirety of all state instances of the edges in the graph that are attributed to a specific time and thus to a specific change to the network topology by their timestamp. Thus, an event is uniquely identified by the respective timestamp of the state instances of the respective edges and thus uniquely indicates in a simple manner that change to the network topology occurred at a specific time in the topology of the low-voltage network.

It is furthermore favorable for the timestamps of the respective state instances assigned to the respective edges in the graph to be used to derive a network topology of at least the subarea of the low-voltage network that is valid for a pre-specifiable time. Thus, it is very easily possible to extract a valid network topology that is valid for a prespecified time or a just a current valid network topology from the graph model. For this purpose, for example, a query is made regarding the state instances or the corresponding event that have or has a timestamp that is valid or relevant for the prespecified time. Here, a relevant timestamp is a timestamp that indicates a time that either matches the prespecified time or, in a time series, is the shortest before the prespecified time, i.e., in the time series, the timestamp is the shortest in the past before the prespecified time. In order, for example, to derive a last valid network topology of at least a subarea of a low-voltage network from the graph model, it is, for example, possible to query the state instances of the edges with the most recent, latest or most current timestamps or the event with the most recent, latest or most current timestamp.

Alternatively or additionally, ideally, a list of changes to the network topology of at least the subarea of the low-voltage network for a specifiable period of time can be derived from the graph model based on the timestamps of the respective state instances that are assigned to the respective edges in the graph. For this purpose, it is, for example, possible to query all state instances of the edges or the corresponding events whose timestamps fall within the prespecified period of time. In this way, it is, for example, possible for changes to the network topology over a specifiable period of time to be determined, output and possibly analyzed in combination with measurement data acquired in this period of time. Effects of switching states in the low-voltage network can, for example, be subsequently tracked more easily and, for example, evaluated by systems for network monitoring.

It is expedient for an active state or a deactivated state to be assigned to an edge as the respective state instance. This means that the respective state instance indicates whether the respective associated edge or the component of the subarea of the low-voltage network represented as an edge was active or deactivated in the timestamp of the respective state instance. Hence, the respective state instance can, for example, indicate whether, for example, a line between two connecting points or nodal points was active (i.e., was transmitting energy) at a specific time or, for example, was interrupted due to a fault or circuit in the network. The state instance can, for example, also indicate whether, for example, an energy generator or an energy storage unit was connected to (=active) or disconnected from (=deactivated) the low-voltage network at the time indicated in the timestamp.

Ideally, when the components are represented as edges and/or as edges with an associated start or end node, connectors of the respective edges to the nodes and state changes to the connectors of the respective edges are taken into account in the graph. Furthermore, when the components are represented as edges and/or as edges with an associated start or end node in the graph, a direction of an energy flow between the components and the associated connecting points in at least the subarea of the low-voltage network is taken into account. For this purpose, in the graph or graph model, instead of the edges the connectors of the edges to the respective nodes (“terminals”) are provided with state instances containing a state for a time of a respective topology change, provided that the respective currently valid state of the respective terminal or edge connector was changed by the respective topology change. Here, a terminal represents a connector of the respective edge or the component modeled by the respective edge (for example, consumer, energy feeder, energy generator or operating equipment) at a node or connecting point in the network. Terminals are, for example, ends of lines or cables, connectors of a transformer, and/or a connector of a consumer or household. These terminals are then assigned the respective changed states (for example, terminal “active”, terminal “deactivated”) that occur as a result of topology via the respective state instances. Terminals that, for example, never change their state are, for example, not assigned a state instance as a result of which the number of state instances can ideally be kept as low as the change events. The measurement of electric current in the low-voltage network usually occurs at the lines or cables, frequently in the vicinity of connectors or connecting points. Consequently, the depiction of the connectors as terminals and the assignment of the state instances, for example, makes it very easy to take account of the energy flow on the line (for example, from the connecting point to the consumer, and/or from the energy feeder or energy generator to the connecting point). This enables the interpretation of measurement data, in particular measured values for electric current, to be improved and facilitated. This makes it easier and quicker for operating and maintenance personnel to localize any errors and faults in the low-voltage network.

It is advantageous for the graph of at least the subarea of the low-voltage network to be modeled based on network planning data or available network management data. This, for example, enables network data or network models already available at a network operator to be used as a starting point for the modeling without requiring a large amount of time. Thus, for example, network planning data from the PSS®Sincal simulation software, which is used, for example, for the planning, design and operational management of electrical transmission, distribution and industrial networks and for other types of networks operated with alternating current (for example, micro grids), can be used as starting data for the modeling.

Ideally, the graph or the graph model of at least the subarea of the low-voltage network is stored and possibly processed in a graph database. The use of a graph database, such as the open-source graph database Neo4j, to represent the network topology of a low-voltage network has the advantage that such databases are already optimized by their structure for the representation of topological relationships and, for example, offer special query languages (for example, SPARQL, Cypher, GraphQL) for processing and further processing of the data. This enables queries, such as a network topology that was current at a specific prespecified time to be performed quickly and time-efficiently.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWING

The invention is explained below in an exemplary manner with reference to the accompanying figures, in which:

FIG. 1 is a schematic exemplary sequence of the method for modeling at least a subarea of a low-voltage network in accordance with the invention;

FIG. 2 is a schematic and exemplary graph model of an exemplary low-voltage network created according to a modeling step of the method in accordance with the invention;

FIGS. 3a to 3c are schematic and exemplary modelings of a subarea of the exemplary low-voltage network represented in FIG. 2;

FIG. 4 is a schematic and exemplary embodiment of the modeling in accordance with the invention of the subarea of the exemplary low-voltage network represented in FIG. 2; and

FIG. 5 is a schematic and exemplary further variant of the modeling in accordance with the invention of at least a subarea of an exemplary low-voltage network.

### DETAILED DESCRIPTION OF THE EXEMPLARY EMBODIMENTS

FIG. 1 shows, in a schematic manner, an exemplary sequence of the method in accordance with the invention for modeling at least a subarea of a low-voltage network. For this purpose, in a modeling step 101, a (static) network topology of at least a subarea of a low-voltage network, which is, for example, to be monitored or in which, for example, changes are to be analyzed and evaluated together with measurement data from the low-voltage network (for example, measurement data for electric current, voltage and/or power), is modeled as a graph with nodes and edges. A representation of the (static) network topology, i.e. the low-voltage network-subarea or the low-voltage network with its components (for example, consumers, energy feeders, energy generators, energy storage units and operating equipment, such as transformers, and/or lines) and connecting points (for example, busbars, loop boxes, and/or disconnection boxes), as a graph or graph model with edges and nodes uses, for example, network planning data from a corresponding database and/or a corresponding network simulation tool or network planning tool, such as PSS®Sincal.

In the graph or graph model, which is created in the modeling step 101, components of the low-voltage network are represented as edges or as edges with an associated start or end point and connecting points of the components in the low-voltage network are represented as nodes. The edges represent, for example, operating equipment of the low-voltage network, such as transformers in transformer stations, lines, and/or cables. Components, such as consumers (for example, single or multiple households, and/or buildings), energy generators connected to the network (for example, a PV power station, and/or small wind turbine), energy feeders from a higher-level network, etc., which, for example, form a boundary or an end point of the low-voltage network, are, for example, represented as an edge with an associated start or end point. Finished modeling of the (static) network topology of at least the subarea of the low-voltage network as a graph can then, for example, be stored in a graph database, such as Neo4j, and subsequently further processed.

In an initialization step 102, a state of the edge or the component represented by the edge that is valid at an initialization time is first determined for each edge of the graph. Here, an edge can, for example, have an active state or a deactivated state. The state of the respective edge determined at the initialization time is assigned to the respective edge as the first state instance or initialization instance. This first state instance of the graph edges can, for example, be provided with a timestamp in which the initialization time is held. Furthermore, the initialization instances of all graph edges can be combined to form a first event, i.e., the initialization event. This initialization event represents an initial network topology of at least the subarea of the low-voltage network.

Subsequently, in a determination step 103, in the event of a change to the network topology of at least the subarea of the low-voltage network, a respective current state that is valid for the respective edge of the graph from a time of the change to the network topology is determined for each edge of the graph. Changes to the network topology occur if, for example, one or more edges change their respective current state. This means, for example, that a line is switched on or off by a circuit in the network, or a fault or interruption occurs, for example, in a line as a result of which another deactivated line must be switched on. This means that the current state of the respective component or the associated edge in the graph changes from a new state that is currently valid after the topology change (for example, from the state “active” to the state “deactivated”, or, for example, from the state “deactivated” to the state “active”). Edges that are not affected by the topology change have the same state after the topology change as before. This means that an active edge remains active even after the topology change, or a deactivated edge remains deactivated even after the topology change, where the current state before the topology change thus remains identical to the currently valid state after the topology change.

The new and currently valid states of the edges (for example, active or deactivated) after the topology change from the determination step 103 are then assigned to the edges in the graph as further state instances in an assignment step 104. Here, the further state instances are provided with a timestamp indicating the time of the change to the network topology depicted by the state instances. The further state instances can then be combined on the basis of their time stamp to form a new event representing a network topology of at least the subarea of the low-voltage network represented by the graph that is valid at the time indicated in the timestamp.

The determination step 103 and the assignment step 104 must be run through for each further topology change of the low-voltage network that is to be processed in the modeling. This means that, in the case of a plurality of topology changes, in addition to the initialization state instance, a further state instance with an associated timestamp is, for example, assigned to the edges in the graph model for each topology change, where the timestamp always indicates the time of the respective topology change.

For purposes of simplicity, in the assignment step 104, a further state instance together with a corresponding timestamp can only be assigned to the edges for which the respective topology change has also led to a state change, i.e., for example, from “active” to “deactivated”, or from “deactivated” to “active”. Thus, only edges affected by the respective topology change receive a new further state instance with a corresponding timestamp. Thus, edges that, for example, never change their state due to topology changes, for example, only have the initialization instance. For example, the state instances of the edges that have the respective most recent time stamp are then combined for the corresponding event.

In a derivation step 105, for example, a network management system or network monitoring system then accesses the graph model which, after the execution of the method for modeling the network topology, in addition to the static network topology of at least the subarea of the low-voltage network, also comprises the dynamic network topology changes. A network topology valid for a specifiable time can now be derived based on the timestamps of the state instances assigned to the edges represented in the graph. Here, for example, the event or state instances of the edges selected are those whose timestamp or timestamps match the prespecified time or, in a time series, is/are the shortest before the prespecified time. This means that the state instances of the edges selected are those which, in a time series, are the shortest in the past before the prespecified time. Furthermore, it is possible that, in derivation step 105, a list of changes to the network topology for a specifiable period of time is determined based on the timestamps of the state instances of the edges or on the basis of the time stamp of the associated event. This list then comprises all events whose timestamps are comprised by the prespecified period of time.

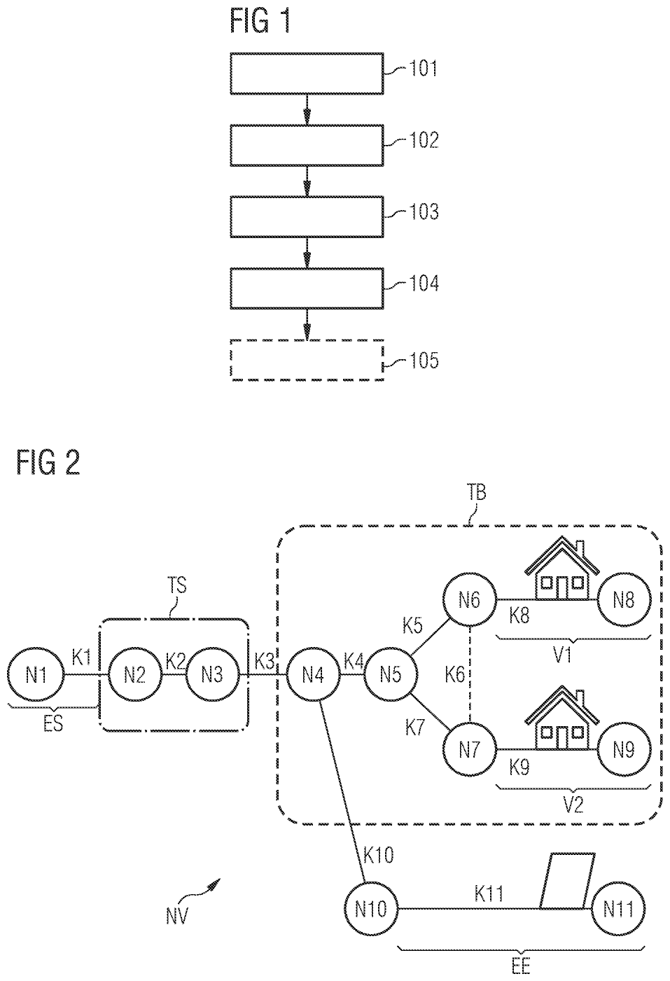

FIG. 2 shows a schematic exemplary representation of a graph of a network topology of an exemplary low-voltage network NV, which was created with the modeling step 101 of the method in accordance with the invention for modeling a network topology. Here, the low-voltage network NV is supplied from a higher-level network (for example, a medium-voltage network) via an energy feeder ES. The energy fed in is brought to the corresponding voltage level via a transformer station TS or the transformer located there and distributed via a busbar N4 and, for example, via a loop box N5 and line strands K4, K5, K7 to two exemplary consumers V1, V2 connected, for example, to the low-voltage network NV via so-called disconnection boxes N6, N7. An energy generator EE (for example, PV power station) is, for example, connected to the low-voltage network NV on a further line strand K10, which links the busbar N4 to a further connecting point N10.

In the modeling step 101, a graph or graph model in which the components ES, TS, V1, V2, EE and lines K3, K4, K5, K6, K7, K10 are represented as edges K3, K4, K5, K6, K7, K10 or edges K1, K8, K9, K11 with an associated start or end node N1, N8, N9, N11 and the connecting points N4, N5, N6, N7, N10 are represented as nodes N4, N5, N6, N7, N10 is modeled from the exemplary low-voltage network NV with its components ES, TS, V1, V2, EE, lines K3, K4, K5, K6, K7, K10 and connecting points N4, N5, N6, N7, N10.

The energy feeder ES forms, for example, a boundary of the low-voltage network. As a result, this is, for example, represented as a start node N1 with an associated edge K1 to which, for example, the respective state instances are then assigned in the further method. The energy feeder ES is, for example, linked via a connecting point N2 to the transformer station TS or to the transformer, where the transformer station TS or the transformer has a further connecting point N3 on the low-voltage side. Therefore, the two connecting points N2, N3 of the transformer station TS are represented as nodes N2, N3 in the graph and the transformer of the transformer station TS, which can assume different states, for example by means of circuits, is modeled as edge K2. The line K3, which links the transformer station TS to the busbar N4, is again represented as edge K3.

The busbar N4 at which a plurality of line strands K3, K4, K10 meet or which forms the connecting point N4 for these line strands K3, K4, K10 is modeled as node N4. The lines K4, K10 leading away from the busbar N4 or the node N4 are again represented as edges K4, K10. Here, for example, a first line K4 or edge K4 leading away from the busbar N4 or the node N4 leads to a loop box N5, which is again represented as node N5. A second line K10 or edge K10 leading away from the node N4 leads to a connecting point N10 modeled as node N10. The energy generator EE is, for example, connected to the network at this connecting point N10. The energy generator EE represents, for example, an end point for the line strand K10. As a result, the energy generator EE is modeled as edge K11 with the associated end node N11 in the graph. The edge K11 can, for example, subsequently then be assigned different states of the energy generator EE.

Connecting points or so-called disconnection boxes N6, N7 for the consumers V1, V2 (for example, household, and/or building) are connected to the loop box K5 represented as node K5, for example, via two exemplary line strands K5, K7, where the line strands K5, K7 are again represented as edges K5, K7 and the connecting points N6, N7 are represented as nodes N6, N7. The two consumers V1, V2 connected to the nodes N6, N7 again represent end points for the respective line strands K5, K7 and are therefore modeled as edges K8, K9 with the associated end node N8, N9. Furthermore, for example, a line, which is modeled as the edge K6 is provided between the connecting points N6, N7. This line K6 is, for example, only activated in the event of a fault or is usually deactivated. Accordingly, the corresponding edge is shown as a dashed line in FIG. 2.

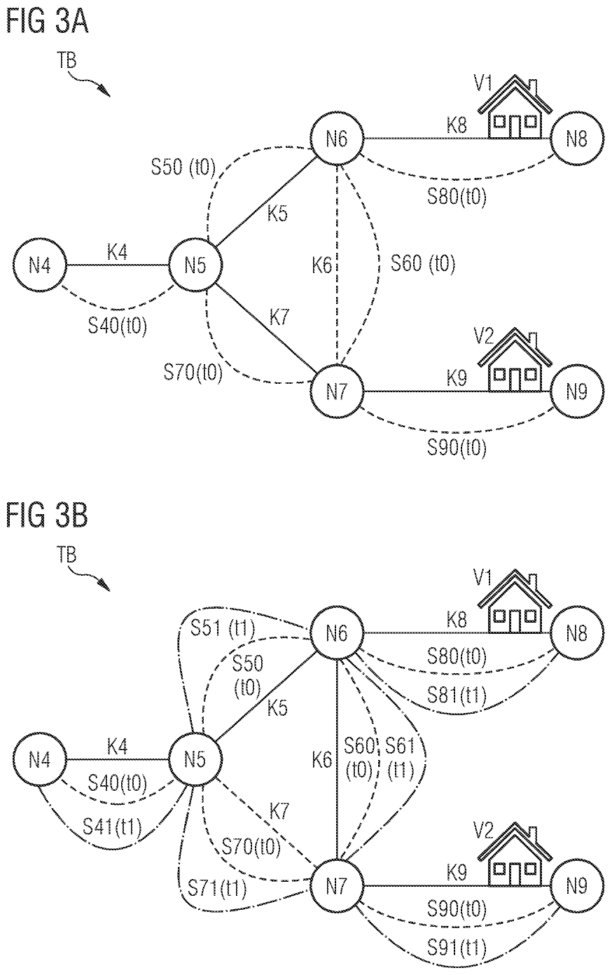

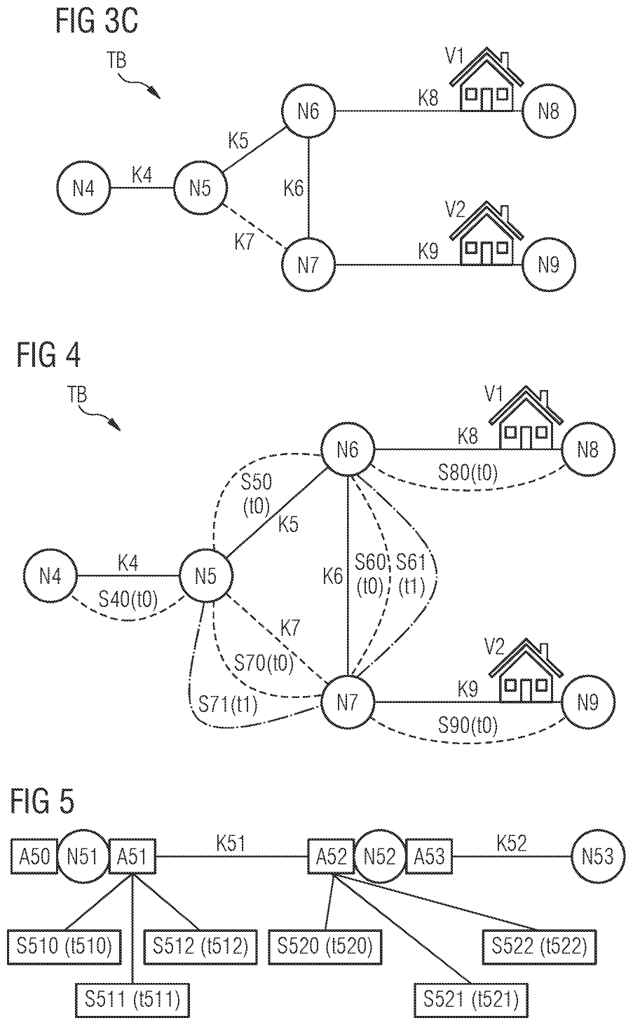

The following explains the further steps of the method for modeling, i.e., the initialization step 102, the determination step 103, the assignment step 104 and an exemplary derivation of a current network topology from the graph model by means of derivation step 105, with reference to FIGS. 3a, 3b and 3c, where, for purposes of simplicity/clarity, FIGS. 3a to 3c only show a subarea TB of the exemplary graph of the low-voltage network represented in FIG. 2. This subarea TB comprises the busbar or the node K4 with the first outgoing line strand K4 or the edge K4, the loop box or the node N5 with the lines or edges K5, K7, which lead to the connecting points or nodes N6, N7, the linking line or edge K6 between the nodes N6, N7 and the two connected consumers V1, V2, which are represented as edges K8, K9 with the associated end nodes N8, N9.

FIG. 3a now shows a schematic and exemplary graph of the subarea TB after the initialization step 102. For this purpose, in the initialization step 102, a current state of the respective edges K4, K5, K6, K7 and the consumer edges K8, K9 at the initialization time t0 is determined. Here, for example, all edges K4, K5, K7, K8, K9, except for the edge K6, which links the nodes N6 and N7, have, for example, an active state. The edge K6 between the nodes N6, N7 is, for example, deactivated and therefore shown as a dashed line. The state determined at the initialization time t0 is then assigned to the respective edges K4, K5, K6, K7, K8, K9 as the first state instance or as an initialization instance S40(t0), S50(t0), S60(t0), S70(t0), S80(t0) and S90(t0) together with a timestamp t0. Here, the timestamp t0 represents the initialization time to. Furthermore, the initialization instances S40(t0), S50(t0), S60(t0), S70(t0), S80(t0) and S90(t0) of all graph edges K4, K5, K6, K7, K8, K9 can be combined to form a first event (the “initialization event”) which represents a network topology of the subarea TB at the initialization time t0.

FIG. 3b now shows an exemplary and schematic implementation of the determination step 103 and the assignment step 104 in the event of an exemplary change to the network topology of the subarea TB of the low-voltage network under consideration, which, for example, occurs or is performed at a time t1. Here, at the time t1, the line K7 is, for example, deactivated by a fault and, for example, the line K6 is activated in order to ensure a further power supply to the second consumer V2. The line or edge K6, which is now active due to the topology change, is therefore represented as a solid line. The line or edge K7, which was, for example, deactivated by a failure or shutdown at the time t1, is now represented as a dashed line.

The new and currently valid states of the edges K4, K5, K6, K7, K8, K9 (for example, active or deactivated) after the topology change, which were determined in the determination step 103, are then, in the assignment step 104, assigned to the edges K4, K5, K6, K7, K8, K9 in the graph of the subarea TB as further state instances S41(t1), S51(t1), S61(t1), S71(t1), S81(t1) and S91(t1). Here, the further state instances S41(t1), S51(t1), S61(t1), S71(t1), S81(t1) and S91(t1) are provided with a timestamp t1, which indicates the time t1 of the change to the network topology. The further state instances S41(t1), S51(t1), S61(t1), S71(t1), S81(t1) and S91(t1) can then be combined based on their time stamp t1 to form a new event representing the network topology of at least the subarea TB of the low-voltage network represented by the graph valid at the time t1 indicated in the timestamp t1.

FIG. 3c shows an exemplary network topology of the exemplary subarea, which can be determined from the graph model, for example, for the time t1, as currently valid network topology in the derivation step 105. Here, the state instances S41(t1), S51(t1), S61(t1), S71(t1), S81(t1) and S91(t1) of the edges with the timestamp t1 for the time t1 or the corresponding event can, for example, be accessed in order to determine the currently valid network topology of the subarea TB at the time t1. The currently valid network topology of the subarea TB again shows the busbar N4 or the node N4 with the connected line or edge K4 leading to the loop box or node N5. Furthermore, it can be seen from the network topology of the subarea TB that the first outgoing line K5 or edge K5 from the loop box N5 is active and supplies the first consumer V1 with energy via the connecting point N6. Furthermore, it can also be identified that the second outgoing line K7 or edge K7 from the loop box N5 is deactivated and the second consumer V2 is now supplied with energy via the first line K5, the connecting point N6 and the line K6 between the connecting points N6, N7, since the line K6 or edge K6 has been activated.

FIG. 4 shows an exemplary embodiment of the implementation of the assignment step 104 in the modeling in accordance with the invention of the subarea TB of the exemplary low-voltage network NV represented in FIG. 2 via which a number of state instances assigned to the edges K4, K5, K6, K7, K8, K9 can be reduced. Similarly to FIG. 3a, in the initialization step 102, the edges K4, K5, K6, K7, K8, K9 are again assigned the first state instances or initialization instances 540(t0), S50(t0), S60(t0), S70(t0), S80(t0) and S90(t0) together with a timestamp to. For the sake of simplicity, however, in the assignment step 104, a further state instance S61(t1), S71 (t1) together with a corresponding timestamp t1 is only assigned to the edges K6, K7 in which the topology change at the time t1 has also led to a state change, i.e., for example, from “active” to “deactivated”, or from “deactivated” to “active”. Thus, this means that the edge K6 between the nodes N6, N7 is assigned a further state instance S61(t1) in addition to the initialization instance S60(t0), since these were switched to active by the topology change at the time t1. Furthermore, the edge K7 between the nodes N5, N7 is assigned a further state instance S71(t1) in addition to the initialization instance S70(t0), since this had failed due to a topology change at the time t1, for example, due to a fault, or had been deactivated due to a circuit. The corresponding event representing the topology change of the subarea TB for the time t1 then, for example, combines the edges K6, K7, the state instance S61(t1), S71(t1) with the timestamp t1 and, for the remaining edges K4, K5, K8, K9, the initialization instances S40(t0), S50(t0), S80(t0) and S90(t0) with the timestamp t0 representing the respective most current state instance for the remaining edges K4, K5, K8, K9.

FIG. 5 represents an exemplary subarea of a low-voltage network. This subarea has, for example, three exemplary nodes N51, N52, N53. In this context, the first node N51 can, for example, be a busbar, which is linked to a second node N52 (for example a loop box) via a first line or edge K51. A third node N53, such as an end node of a consumer is, for example, connected to the second node N52 or the loop box via a second line or edge K52. Here, the first and the second node N51, N52 have connectors or terminals A50, A51, A52, A53. Here, a first end of the line or edge K51 is connected to a first connector A51 of the first nodes N51. The second end of the line or edge K51 is connected to a first connector A52 of the second node N52. The consumer (represented as a second edge K52 and end node N53) is, for example, connected to the second connector A53 of the second node N52. A second connector A50 of the first node N51 is only shown for purposes of completeness and can, for example, represent a connector for a link to a transformer station.

In the exemplary embodiment of the method for modeling a network topology of a low-voltage network represented in FIG. 5, instead of edges K51, K521 and their respective state changes, due to topology changes, the connectors A51, A52, A53 or the terminals A51, A52, A53 and thus the corresponding ends of the lines K51, K52 are considered. In this context, changes at the level of the terminals A51, A52, A53 are acquired by creating a state instance S510, S511, S512, S520, S521, S522 for each change to the terminals in the graph model and assigning it to the respective terminal A51, A52. Based on this, each change in the state of a connector or a terminal A51, A52, A53 over a period of time under consideration can be represented and stored in the graph model. Terminals, such as the second terminal A53 of the second node N52, for which no state changes occur over the period of time under consideration, are not assigned a state instance.

In these state instances S510, S511, S512, S520, S521, S522, states, such as “active”, and/or “deactivated”, of the terminal A51, A52 and at least the time t510, t511, t512, t520, t521, t522 at which a change to the respective state “active”, and/or “deactivated”, has occurred, can, for example, be held as information. Depending upon the application, additional information can be added to these state instances S510, S511, S512, S520, S521, S522, such as details of a technician who has executed a state change or the quality of information (for example, whether the respective state was already registered in a database at the indicated time t510, t511, t512, t520, t521, t522 or whether the state change was, for example, executed by the technician on site).

Based on the exemplary embodiment illustrated in FIG. 5, the respective valid state of the respective connector or terminal A51, A52, A53 and thus a correspondingly valid network topology can likewise be extracted by a corresponding query at any time in the past. For example, a corresponding query can be used to query all terminals A51, A52, A53 that are active at a prespecified time and thus to infer a network topology that was current at the prespecified time. Furthermore, in the exemplary modeling embodiment represented in FIG. 5, it is also, for example, possible to take account of a direction of the energy flow between the components or between the connectors A51, A52, A53 in the modeled low-voltage network.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A computer-implemented method for modeling a network topology of at least a subarea of a low-voltage network comprising components connected to at least the subarea of the low-voltage network via connecting points, the network topology of at least the subarea of the low-voltage network being changed by at least one of (i) switching on, over, or off components comprising lines and (ii) adding or removing components comprising at least one of operating equipment, consumers and energy generators or energy storage units, the method comprising:
modeling the network topology of at least the subarea of the low-voltage network as a graph with nodes and edges, the components connected to at least the subarea of the low-voltage network via connecting points being represented as at least one of edges and edges with an associated start or end node and the connecting points being represented as nodes;
determining a state valid at an initialization time for each edge and assigning said determined state to a respective edge as the first state instance;
determining a respective current state which is valid for a respective edge of the graph from a time of a respective change to the network topology is determined for each edge of the graph in an event of the respective change to the network topology; and
assigning each edge of the graph the respective state determined and currently valid from the time of the respective change to the network topology as a respective further state instance together with a timestamp which indicates the time of the respective change to the network topology.

2. The method as claimed in claim 1, wherein an assignment of respective further state instances with an associated timestamp is reduced to those edges of the graph (104) whose respective current state was changed by the respective change to the network topology in the event of the respective change to the network topology.

3. The method as claimed in claim 1, wherein the respective change to the network topology of at least the subarea of the low-voltage network is combined to form an event.

4. The method as claimed in claim 2, wherein the respective change to the network topology of at least the subarea of the low-voltage network is combined to form an event.

5. The method as claimed in claim 1, wherein the timestamps of the respective state instances assigned to the respective edges in the graph are utilized to derive a network topology of at least the subarea of the low-voltage network which is valid for a specifiable time.

6. The method as claimed in claim 1, wherein the timestamps of the respective state instances assigned to the respective edges in the graph are utilized to determine a list of changes to the network topology of at least the subarea of the low-voltage network for a specifiable period of time.

7. The method as claimed in claim 1, wherein an active state or a deactivated state is assigned to an edge as the respective state instance.

8. The method as claimed in claim 1, wherein connectors of the respective edges to the nodes and state changes to the connectors or the respective edges are taken into account in the graph when the components connected to at least the subarea of the low-voltage network via connecting points are represented as at least one of (i) edges and (ii) edges with an associated start or end node.

9. The method as claimed in claim 1, wherein a direction of an energy flow between the components and the associated connecting points in at least the subarea of the low-voltage network is taken into account (102, 104) when the components connected to at least the subarea of the low-voltage network via connecting points are represented as at least one of (i) edges and (ii) edges with an associated start or end node in the graph.

10. The method as claimed in claim 1, wherein the graph of at least the subarea of the low-voltage network is modeled based on network planning data.

11. The method as claimed in claim 1, wherein the graph of at least the subarea of the low-voltage network is stored and processed in a graph database.
